(19) United States
(12) Patent Application Publication
(10) Pub. No.: US 2026/0326332 A1
(43) Pub. Date: Oct. 22, 2026

(54) Cutting apparatus

(71) Applicant: FAM, Kontich (BE)

(72) Inventor: Philippe VAN PARIJS, Kontich (BE)

(73) Assignee: FAM, Kontich (BE)

(21) Appl. No.: 19/660,299

(22) Filed: Apr. 28, 2026

Related U.S. Application Data
(62) Division of application No. 18/882,816, filed on Sep. 12, 2024.

(30) Foreign Application Priority Data
Sep. 18, 2023 (EP) 23197883.4

(51) Int. Cl. B26D 7/26; B26D 3/22; B26D 7/06

(52) U.S. Cl. CPC B26D 7/2614; B26D 3/22; B26D 7/0691; B26D 7/0641; B26D 2210/02

(57) ABSTRACT

A cutting apparatus for cutting product into slices, strips or dices includes a feed drum to which product to be cut is fed and wherein the product is moved towards a peripheral opening in the drum; and a set of cutting tools which are mounted at said peripheral opening in the drum and are provided for cutting the product. The set of cutting tools includes at least a slicing knife for cutting a slice from the product and a slice guide. A slice thickness of the slice is defined by a distance between the slicing knife and the slice guide, and is preset by means of a fixing mechanism that positions and fixes the slice guide with respect to the slicing knife. The fixing mechanism provides for a linear displacement of the slice guide with respect to the slicing knife to set the slice thickness while maintaining the orientation of the slice guide with respect to the slicing knife.

### FIELD OF THE DISCLOSURE

The present disclosure relates to a cutting apparatus for cutting product, in particular food product, into slices, strips or dices.

### BACKGROUND ART

U.S. Pat. No. 5,722,143 A discloses a spindle carrier and holder for a cutting apparatus. The carrier is provided for carrying and holding a spindle of a machine during removal and installation of the spindle and while performing maintenance on the spindle. The carrier has a spindle support, a carrying handle, and a device for engaging a portion of the machine so as to removably support the carrier on the machine. The carrier has opposite end plates, each end plate having a recess configured to receive a portion of the spindle such that the spindle may be supported on the end plates in the recesses. In use, the carrier is removably supported on a portion of the machine by attachment members which may be movably mounted on the end plates and attached to the carrier handle. By extending the attachment members, the carrier is supported on the machine and positioned so that the spindle is located in the recesses in the end plate. This enables a single person to then remove the shaft supporting the spindle on the machine while the carrier holds the spindle in position.

U.S. Pat. No. 9,604,379 B2 discloses a dicing machine. The machine has a dicing unit that has a feed drum, circular cutter, and cross-cutter each individually rotatably mounted to a support structure by cantilevered shafts. The machine further has a knife for producing slices of a solid or semisolid material, circular knives on the circular cutter to cut the slices into strips, and cross-cut knives on the cross-cutter to dice the strips. The machine also has a stripper plate for removing the strips from the circular cutter, and an outboard support assembly for supporting and radially centring outboard ends of the shafts of the feed drum, circular cutter, and cross-cutter and for supporting and securing the stripper plate relative thereto.

### SUMMARY OF THE DISCLOSURE

It is an aim of the present disclosure to provide a cutting apparatus wherein the cutting tools for cutting food product into slices, strips or dices, or at least a subset thereof, can be more easily and safely installed or and/or removed from the cutting apparatus.

It is a second aim of the present disclosure to provide a cutting apparatus which allows more accurate positioning of the cutting tools, or at least a subset thereof, in particular a slicing knife and a slice guide, with respect to each other.

In a first aspect, which may be combined with other aspects and/or embodiments described herein, the present disclosure relates to a cutting apparatus for cutting product into slices, strips or dices, the cutting apparatus comprising: a feed drum to which product to be cut is fed and wherein the product is moved towards a peripheral opening in the drum; and a set of cutting tools which are in use mounted at said peripheral opening in the drum and provided for cutting the product, the set of cutting tools comprising a slicing knife for cutting a slice from the product, a slice guide for guiding the cut off slice, and optionally a circular cutter and/or a cross cutter for further cutting the slice into strips or dices. At least a subset of the cutting tools is mounted on a removable cutting tool housing. The cutting apparatus further comprises an auxiliary mounting system for supporting the removable cutting tool housing upon installation on and removal from the cutting apparatus, the auxiliary mounting system comprising guide means which are provided for guiding the removable cutting tool housing between a first position and a second position, the first position being a use position wherein the housing is mounted adjacent the peripheral opening in the drum and the second position being a predefined position on the guide means wherein the housing is spaced from the drum and can be removed from the guide means.

The auxiliary mounting system facilitates the installation and removal of the cutting tool housing with the subset of cutting tools (herein also called “cutting unit”) on/from the cutting apparatus. In particular, upon removal the auxiliary mounting system allows the cutting tool housing to be first moved from its first, use position to the predefined second position, where the cutting tool housing is as it were presented to a user for easy removal from the cutting apparatus. In this second position, the user can lift or tilt the cutting tool housing and take it from the auxiliary mounting system. Similarly, upon installation of the cutting tool housing the auxiliary mounting system offers the predefined second position as a kind of platform where the used can first put down the cutting tool housing and subsequently push the housing along the guide means to the use position.

In embodiments, the guide means may comprise guide surfaces, preferably wherein the second position is defined by notches in the guide surfaces for receiving complementary parts of the cutting tool housing.

In embodiments, the guide surfaces may have a downward slope from the second position towards the first position, which may facilitate the movement from the second position to the first position by gravity. The angle of the slope is preferably in a range from 0 to 10°.

In embodiments, the guide surfaces may extend substantially perpendicular to a cutting plane which is defined by the slicing knife in use.

In embodiments, the cutting apparatus may comprise mounting studs for receiving the removable cutting tool housing, preferably wherein the mounting studs extend substantially parallel to the guide surfaces. Preferably, in the second position the cutting tool housing is completely removed from the mounting studs. Preferably, the guide surfaces support the cutting tool housing at least part of the way between the first and second positions to protect threaded ends of the mounting studs.

In embodiments, the auxiliary mounting system may comprise one or more support arms, the guide means being provided on the one or more support arms. Preferably, the support arms are movably mounted on the cutting apparatus between a use position and a storage position.

In embodiments, the slice thickness of the slice may be (primarily) defined by a distance between the slicing knife and the slice guide which is preset by means of a fixing mechanism for fixing the slice guide on the housing.

In embodiments, an adjustable gate of the apparatus, which is a movable segment of the drum leading up to the peripheral opening, may be adjusted to match a slice thickness (primarily) defined by means of the slice guide on the cutting tool housing.

In embodiments, the cutting tool housing may comprise an abutment edge as an abutment for a distal portion of the gate.

In a second aspect, which may be combined with other aspects and/or embodiments described herein, the present disclosure relates to a cutting unit, provided for being removably mounted on a cutting apparatus for cutting product into slices, strips or dices, preferably a cutting apparatus as disclosed herein. The cutting unit comprises: a cutting tool housing, provided for being mounted on the cutting apparatus; and a set of cutting tools which are in use provided for cutting the product. The set of cutting tools may comprise one or more of: a slicing knife for cutting a slice from the product, a slice guide for guiding the cut off slice, and optionally a circular cutter and/or a cross cutter for further cutting the slice into strips or dices. A slice thickness for the cutting apparatus is preset on the cutting unit by means of the distance between the slicing knife and the slice guide.

Providing the set of cutting tools on the cutting tool housing, i.e. on a separate, removable cutting unit, has the advantage that their relative positions can be accurately set and secured before placement of the cutting unit on the machine.

In embodiments of the cutting unit, the slice guide may be mounted on the cutting tool housing by means of a fixing mechanism which allows adjustment of the distance and/or the orientation of the slice guide with respect to the slicing knife. Preferably the fixing mechanism allows a linear adjustment of the position of the slice guide which keeps the orientation of the slice guide with respect to the slicing knife.

In embodiments of the cutting unit, the cutting tool housing comprises an abutment edge as an abutment for a gate of the cutting apparatus.

In a further aspect, the present disclosure provides a cutting system comprising a cutting apparatus as disclosed herein in combination with one or more cutting units as disclosed herein.

### BRIEF DESCRIPTION OF THE DRAWINGS

Embodiments of the present disclosure will be discussed in more detail below, with reference to the attached drawings.

FIG. 1A shows a perspective view of an embodiment of a cutting apparatus according to the present disclosure. FIG. 1B shows a detail of FIG. 1A.

FIG. 2A shows the embodiment of FIG. 1A wherein a hood, which covers the cutting tools during use, is opened. FIG. 2B shows a detail of FIG. 2A. FIGS. 2C and 2D show cross-sectional views of what is shown in FIG. 2B.

FIG. 3A shows the embodiment of FIGS. 1A and 2A with the hood opened and the cutting tools removed. FIG. 3B shows a detail of FIG. 3A.

FIGS. 4A through 7A show in successive perspective view the procedure for installing a removable cutting tool housing on the cutting apparatus. FIGS. 4B through 7B show corresponding cross-sectional views.

FIGS. 8A and 8B show a further step in the procedure of installing the cutting tool housing.

FIGS. 9A and 9B show views of a first cutting tool housing wherein the cutting tools are set for cutting a first slice thickness.

FIGS. 10A, 10B, 10C, 10D and 10E show views of a second cutting tool housing wherein the cutting tools are set for cutting a second slice thickness.

FIG. 11 shows a view of an alternative cutting tool that can be used in a cutting tool housing according to the disclosure.

### DESCRIPTION OF EMBODIMENTS

Below, particular embodiments according to the disclosure are described with reference to certain drawings but the disclosure is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

Furthermore, the various embodiments, although referred to as “preferred” are to be construed as exemplary manners in which the disclosure may be implemented rather than as limiting the scope of the disclosure.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present disclosure, the only enumerated components of the device are A and B, and further the claim should be interpreted as including equivalents of those components.

### Cutting Apparatus

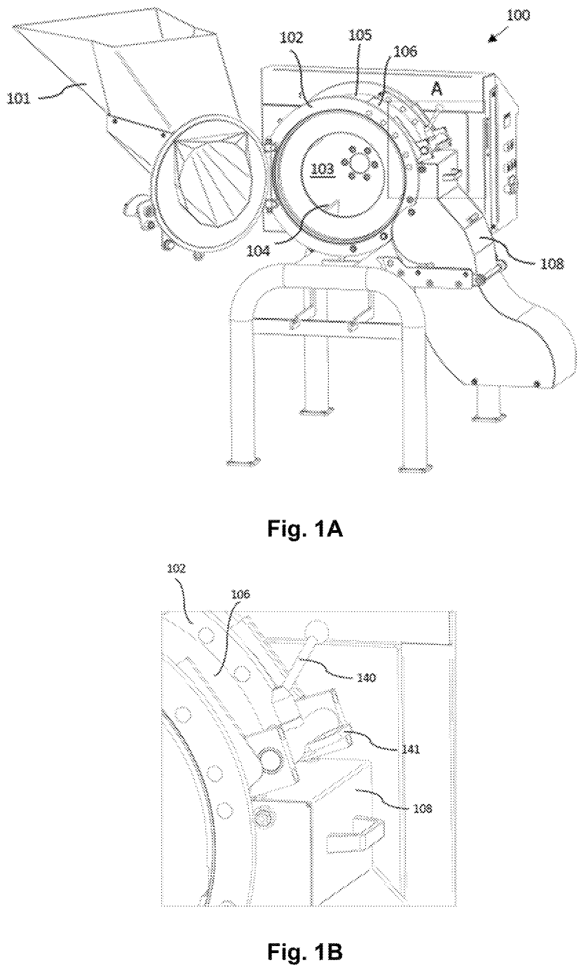

An embodiment of a cutting apparatus or machine according to the present disclosure is shown in FIGS. 1-3. In these figures an area of interest “A” is indicated and shown in more detail.

FIG. 1A shows a perspective view of the cutting apparatus. FIG. 1B shows a detail of the area of interest “A” of FIG. 1A.

The cutting apparatus 100 comprises a feed chute 101 via which product, in particular food product to be cut, is fed into the apparatus. The feed chute is hingedly mounted on a front side of the apparatus and is shown in hinged open position. The feed chute connects to a cylindrical drum 102, wherein the product to be cut is rotated by an impeller 103. The impeller has paddles 104 which move the product along the peripheral wall 105 of the drum and also urge the product towards the peripheral wall by centrifugal force. The paddles move the product in the direction of rotation of the impeller 103 along the peripheral wall of the drum and along a gate 106 towards a peripheral opening 107, at which the cutting tools 110 of the apparatus are mounted. In use, the cutting tools are covered by a hood 108.

The gate is a movable portion of the peripheral wall of the drum. In particular, the position of the gate 106 can be adjusted in view of the slice thickness. For a larger slice thickness, the gate is opened more to create a larger gap at the peripheral opening 107, and vice versa. This will be explained in more detail below. In the embodiment shown, the gate is manually operable to adjust its position and once it is set to the desired position it may be secured in this position by means of bolts or the like.

In the embodiment shown, the (food) product is supplied to the drum through the feed chute 101 by gravity. In alternative embodiments, product may also be supplied to the drum by other feeding means, such as for example a conveyor belt.

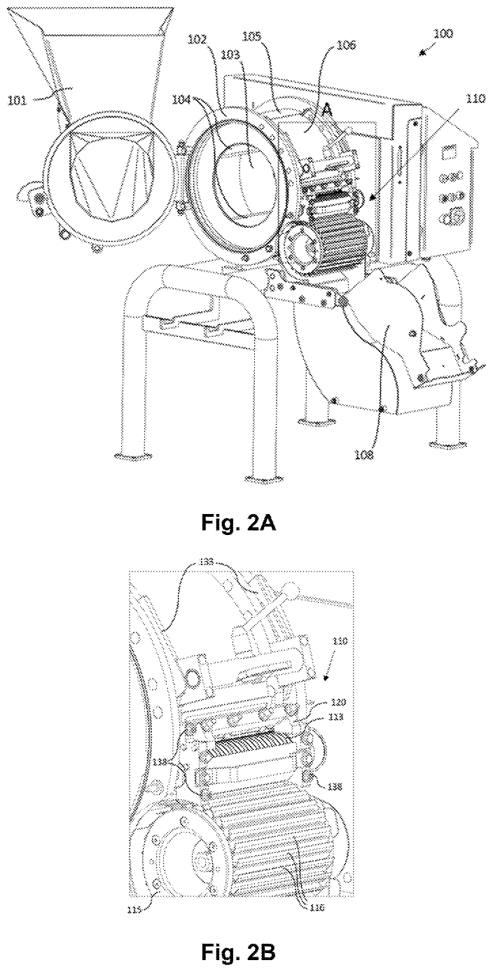

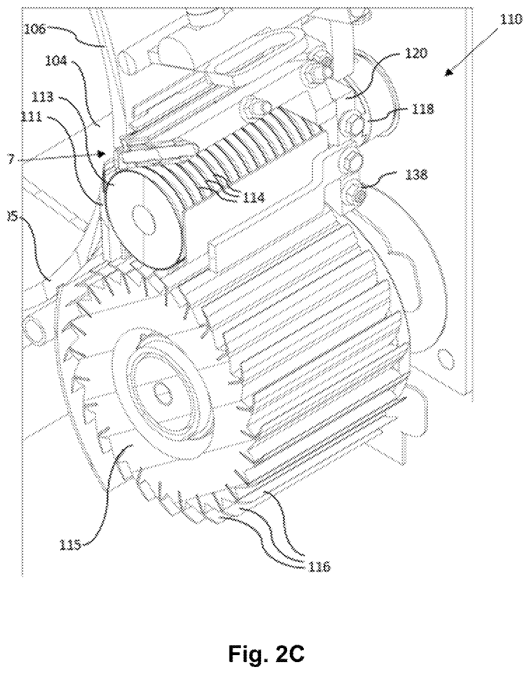

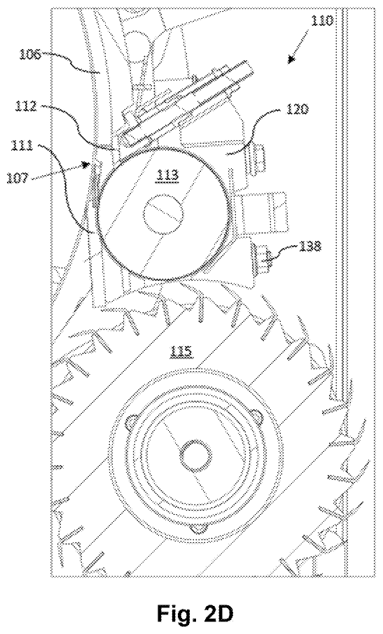

FIG. 2A shows the cutting apparatus 100 with the hood 108 opened, so that the cutting tools 110 are exposed. FIG. 2B shows a detail of the area of interest “A” of FIG. 2A. FIGS. 2C and 2D show cross-sectional views.

In the embodiment shown, cutting tools 110 are provided for cutting the product into dices. A cutting apparatus 100 within the scope of the present disclosure may be generally equipped with cutting tools for slicing, strip cutting or dicing. This means that the set of cutting tools may comprise a slicing knife 111 for cutting a slice from the product, a slice guide 112 for guiding the cut off slice, and optionally a circular cutter 113 and/or a cross cutter 115 for further cutting the slice into strips or dices. In embodiments according to the present disclosure, at least a subset of the cutting tools may be provided on a removable cutting tool housing 120.

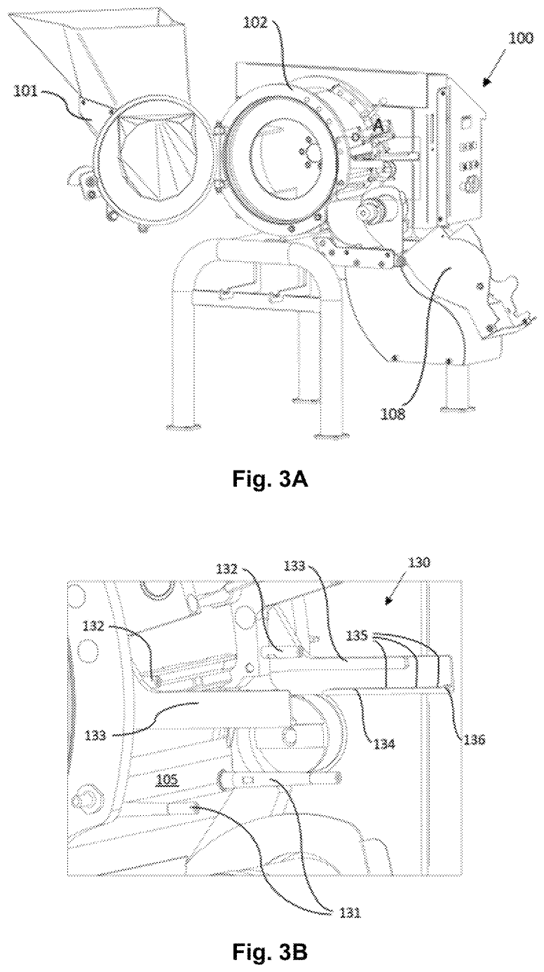

FIG. 3A shows the cutting apparatus of FIGS. 1A and 2A with the hood 108 opened and the cutting tools 110 removed. FIG. 3B shows a detail of FIG. 3A.

For installation and removal of at least a subset of the cutting tools 110, in particular the subset of cutting tools provided on the removable housing 120, the apparatus comprises an auxiliary mounting system 130 for supporting the removable cutting tool housing upon installation on and removal from the cutting apparatus. The auxiliary mounting system comprises guide means, in particular a pair of guide arms or brackets 133, which are provided for guiding the removable cutting tool housing between a first position and a second position. The first position is the position in use on the apparatus, wherein the housing 120 is mounted adjacent the peripheral opening in the drum and the cutting tools are in position for the cutting operation. The second position is a position for removal or installation, in particular a predefined position on the guide arms wherein the housing 120 is spaced from the drum and can be easily (manually) lifted from the guide arms 133. The second position may be predefined, for example by means of notches 135 in the support surface 134 of the guide arms.

The apparatus comprises mounting studs 131, 132 on which the removable cutting tool housing 120 is mounted in use. The mounting studs 131, 132 are provided on the drum, preferably on the peripheral wall 105 of the drum. The cutting tool housing 120 is provided with through bores for receiving the mounting studs. Upper mounting studs 132 are provided for fixing an upper portion of the cutting tool housing 120 and lower mounting studs 131 are provided for fixing a lower portion of the cutting tool housing on the apparatus. The lower mounting studs 131 are preferably provided on a portion of the peripheral wall 105 that is configured for receiving the slicing knife 111. The slicing knife 111 preferably also has through bores which are aligned with the bores in the cutting tool housing and also receive the lower mounting studs 131. In this way, the lower mounting studs 131 also fix the slicing knife 111 on the machine. Preferably, the mounting studs 131, 132 extend generally parallel to the support surface on the guide arms 133 and have threaded distal ends on which mounting nuts 138 (shown in FIG. 2B-2D) are screwed to secure the cutting tool housing 120 on the machine during use.

In the embodiment shown, the guide arms or brackets 133 are in themselves movable between a use position, shown in FIG. 3, and a storage position, shown in FIGS. 1 and 2. In particular, the guide arms 133 can be hinged upwards to the storage position so that they form no obstacles for closing the hood 108 of the apparatus. In alternative embodiments, the guide arms could also be removable parts of the machine which are only put in place upon installation or removal of a cutting tool housing on or from the machine.

### Cutting Tools

The cutting tools 110 will now be generally described with reference to FIGS. 2A-2D.

In the embodiment shown, cutting tools 110 are provided for cutting the product into dices. A first cut is the cutting off of a slice of the product by means of a slicing knife 111. Subsequently, the slice is transversally cut by a circular cutter 113, which comprises a series of circular knives 114 mounted on a spindle at equal distances from each other. The circular cutter 113 cuts the slice into strips. Subsequently, the strips are cut into dices by a cross cutter 115, which comprises a plurality of cross cut knives 116 mounted on another spindle and oriented for cutting the strips in cross direction.

The slicing knife 111 may be a single-piece knife or an assembly. In the embodiments shown in the drawings, the slicing knife comprises a holder with a replaceable insert that comprises the cutting edge. Such slicing knives are known as such and will therefore not be described in detail herein.

The circular cutter 113 comprises a plurality of circular knives 114 which are mounted on a spindle with spacers in between each pair of circular knives. Such circular cutters are known as such and will therefore not be described in detail herein. The spindle of the circular cutter 114 is coupled with a drive spindle of the machine by mating parts 118, 119 forming a tooth and groove connection. In this way, the circular cutter spindle can be connected to or disconnected from the drive spindle by a simple, lateral movement, in particular by first (manually) rotating the spindle and drive spindle to align the direction of the tooth and groove with the direction in which the cutting tool housing 120 is installed or removed and then sliding the cutting tool housing 120 into the (first) use position or from the use position to the (second) position for removal.

In embodiments, the cutting tools may also comprise a spindle with feed stars instead of the circular cutter 113. Such feed stars do not cut the slice of the product but engage the slice to move it forward to the cross cutter. Such a spindle with feed stars is shown in FIG. 11.

The cross cutter 115 is an assembly of cross cut knives 116 onto another spindle, which may be connectable to a drive spindle of the machine in a similar way, or bolted to this drive spindle like in the embodiment shown. Such cross cutters are known as such and will therefore not be described in detail herein.

The cutting tools 110 further comprise a slice guide 112, which in embodiments of the present disclosure defines the slice thickness. The slice guide 112 may be formed by or comprise a generally straight plate which is mounted substantially parallel to the outward facing surface of the slicing knife 111, or which extends at a small angle relative thereto, such as for example an angle of 0.0 to 2.0°, preferably 0.1 to 1.0°, preferably about 0.5°. Such a small angle has the effect that the gap through which a slice passes slightly widens towards the exit, which may reduce or eliminate the risk of obstruction or blockage, while simultaneously guiding and holding the slice for the successive cuts of the circular cutter 113 and the cross cutter 115. The plate of the slice guide 112 has slots which accommodate the circular knives 114, i.e. the circular knives pass through these slots and extend towards the outward surface of the slicing knife.

In embodiments of the present disclosure, the slice guide 112, in particular its position with respect to the slicing knife 111, defines or sets the slice thickness of the machine 100. The position of the gate 106 of the drum 102 is set or adjusted such that it matches the position of the slice guide 112. This will be explained further below.

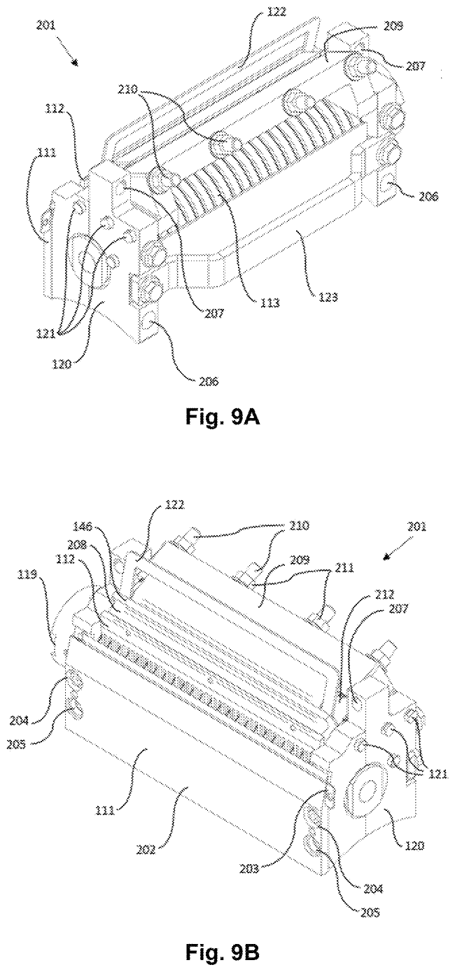

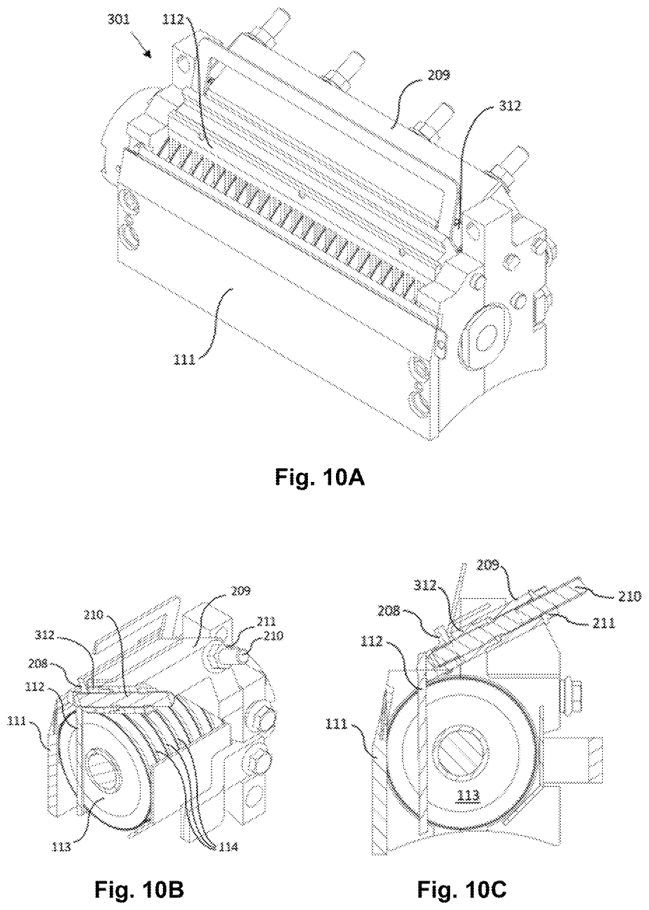

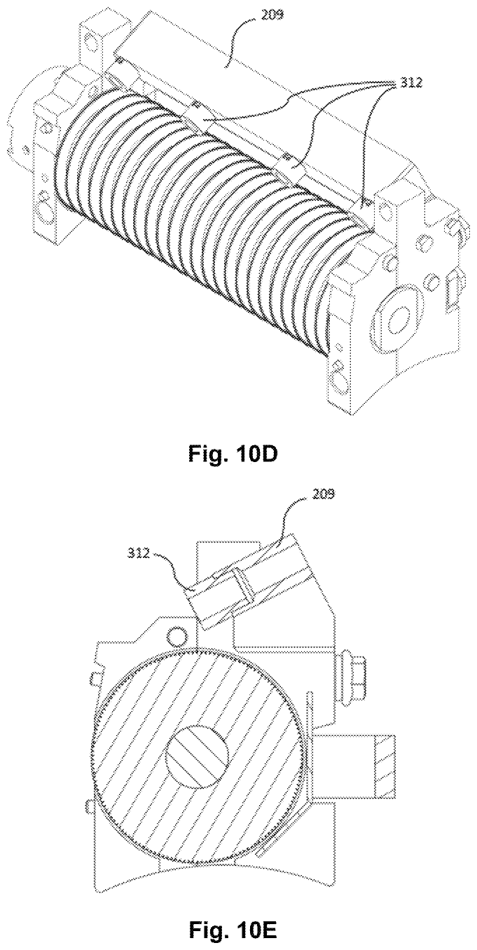

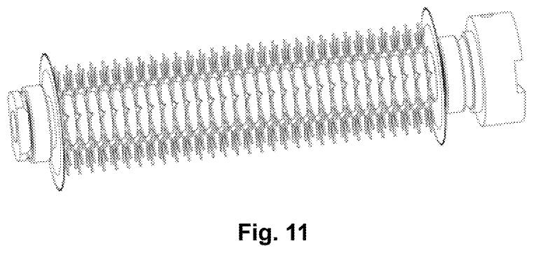

According to the present disclosure, the set of cutting tools 110, or at least a subset thereof, may be mounted on a cutting tool housing 120 which is removable from the cutting apparatus as a unit. In other words, the cutting tool housing 120 and the cutting tools mounted thereon together form a removable cutting unit. The unit can be removed from the apparatus for maintenance, cleaning, sharpening of cutting tools, replacement of worn parts etc. Within the scope of the present disclosure, a set of removable, interchangeable cutting units may be provided, so that a cutting unit which is removed for maintenance can be easily and quickly switched for another one and downtime of the machine can be minimized. Further, multiple different heads may be provided with each head being pre-assembled for a different cut of the product. For example, separate cutting units may be provided for different dimensions of slices, strips and/or dices, and/or for cutting different shapes such as for example crinkle fries. The interchangeability of the cutting units further has the advantage that switching one cutting unit for another one can be performed by a less skilled worker whereas the more skilled worker can focus on tasks like as disassembling and accurately reassembling the cutting units. FIGS. 9 and 10 show embodiments of such interchangeable cutting units.

In the embodiment shown, the subset of cutting tools that are mounted on the removable cutting tool housing 120 comprises the slicing knife 111, the slice guide 112 and the circular cutter 113. Providing these cutting tools on the removable housing 120 has the advantage that their relative positions can be accurately set and secured before placement of the cutting tool housing 120 on the machine 100. The cross cutter 115 is mounted separately on the cutting apparatus 100. In this way, the machine can be easily switched between strip cutting (without the cross cutter) and dicing (with the cross cutter in place). A further advantage is that the weight of both assemblies, i.e. the cutting tool housing 120 (with the knife 111, slice guide 112 and circular cutter 113) and the cross cutter, is manageable so that both assemblies can be removed and installed by a single user.

In embodiments within the scope of the present disclosure, a cutting apparatus may be equipped with cutting tools for slicing only, i.e. a slicing knife and slice guide or a similar element, preferably provided on a removable cutting tool housing 120.

In embodiments within the scope of the present disclosure, a cutting apparatus may be equipped with cutting tools for strip cutting. This can be achieved by adding a circular cutter 113 to the slicing knife 111 and slice guide 112, preferably together on a removable cutting tool housing 120, so that first a slice is cut off which is subsequently longitudinally cut into strips. This can also be achieved by adding a cross cutter 115 to the slicing knife 111 and slice guide 112, so that first a slice is cut off which is subsequently transversely cut into strips. The latter option can for example be used for cutting (dual) crinkle cut fries with the machine being equipped with a corrugated slicing knife and a cross cutter with corrugated cross cut knives.

### Auxiliary Mounting System

The auxiliary mounting system will be clarified with reference to FIGS. 3-7. These figures show in sequence the procedure for installing a cutting tool housing 120 on the cutting apparatus 100. Removal of the cutting tool housing from the apparatus may be performed in the reverse sequence.

FIGS. 3A and 3B show a first situation wherein the cutting tools are completely removed from the apparatus. In order to install the cutting tool housing, a user first moves the guide arms 133 of the auxiliary mounting system to their use position. In this position, the guide arms 133 extend sideways from the drum. In their storage position (shown in FIGS. 1-2) the guide arms are hinged upwards. So the user first moves the guide arms 133 downwards until they hit the stop 137 which is provided on the machine and defines the use position for the guide arms 133. Further, the user manually rotates the drive spindle to align the tooth 118 on the drive spindle with the guide arms 133. For this purpose, a knob may be provided on the machine, for example on a control panel, which is rotationally coupled to the drive spindle. Aligning the tooth 118 in this direction allows to slide the groove 119 (see also FIG. 9B) in the complementary part of the cutting tool housing over the tooth to couple the circular cutter spindle with the drive spindle.

The guide arms 133 are symmetrical with respect to each other and have, on the sides facing each other, a support surface or guide surface 134 on which the cutting tool housing is supported and guided upon installation or removal. This surface has a number of notches 135 for receiving complementary protrusions on the outside of the cutting tool housing. These notches define a position in which the cutting tool housing is stopped upon placement on the guide arms or upon being removed from the use position along the guide arms. This predefined position is herein termed the “second position” whereas the use position for the cutting tool housing is termed the “first position”. The arms 133 further have end stops 136 at their distal ends to prevent that the cutting tool housing would slide off the support system.

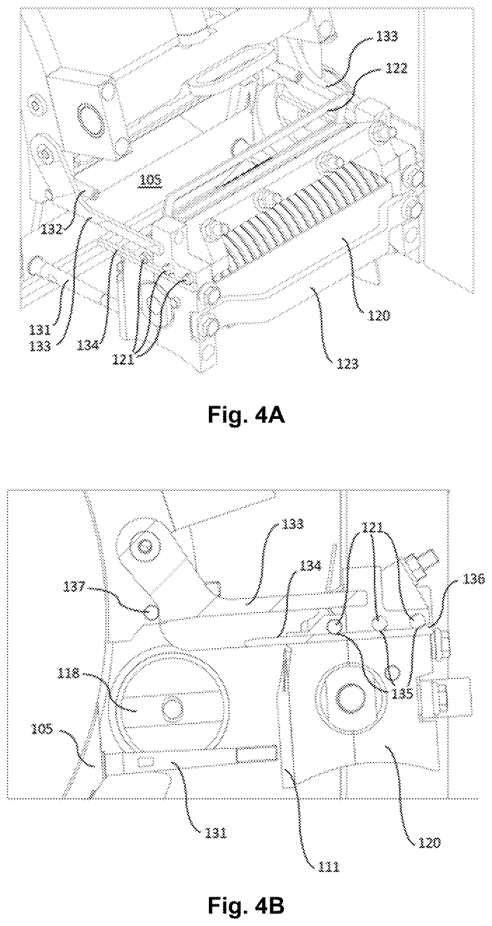

FIGS. 4A and 4B show a second situation in which the cutting tool housing 120 is placed on the end of the guide arms 133. As can be seen, the protrusions 121 on the housing fall into the notches 135 of the support surface 134, i.e. the cutting tool housing is in the predefined, second position. In this position, the cutting tool housing 120 can be easily removed or tilted from the auxiliary mounting system. To this end, the cutting tool housing 120 comprises a handle 122 at the top.

In the embodiment shown, each arm 133 has three notches 135. The mutual distances between the notches is asymmetrical, i.e. the distance D1 between the first and the second notch differs from the distance D2 between the second and the third notch. The purpose of this is that, as the cutting tool housing is pushed along by the user for moving it towards the first position (use position), there are always at least two protrusions that are supported on the support surface and that, as a result, the cutting tool housing does not fall into the subsequent notches as it is pushed along from the predefined, second position.

In the embodiment shown, the support surfaces 134 extend at an angle with respect to horizontal, thus forming a downward slope towards the first position for the cutting tool housing. The angle is preferably in a range from 0 to 10°. Preferably, the support surfaces 134 extend substantially parallel to the mounting studs 131, 132. Further, the support surfaces 134 and mounting studs 131, 132 preferably extend generally perpendicular to the plane of the first cut, i.e. the outward facing surface of the slicing knife (outward with respect to the interior of the drum).

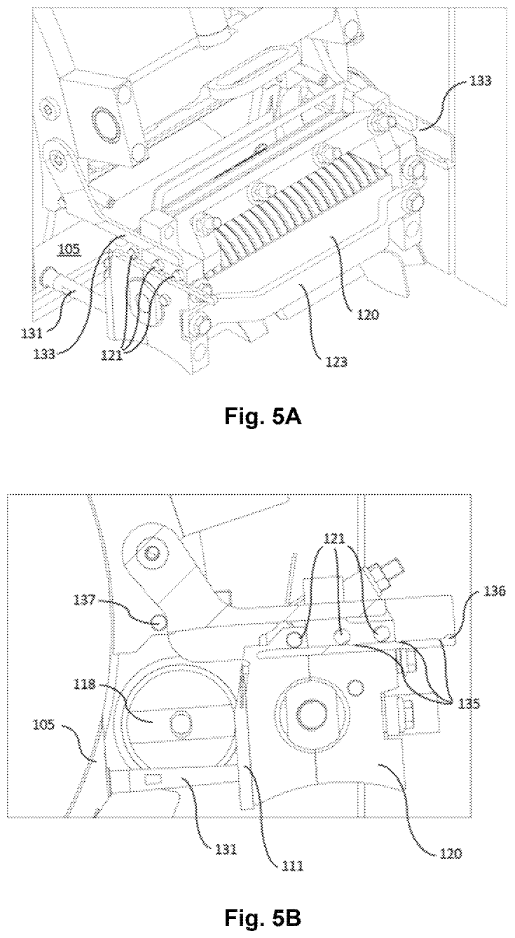

FIGS. 5A and 5B show a third situation in which the cutting tool housing 120 is pushed beyond the notches 135 and is in an intermediate position between the first and second positions. To this end, the cutting tool housing comprises a handle 123 on a side facing the user. As shown, the guide arms 133 are still supporting the cutting tool housing 120 in this intermediate position while the cutting tool housing is already partly over the mounting studs 131, 132. This is preferred to avoid damaging the threaded distal portion of the mounting studs upon installing and removing the cutting tool housing.

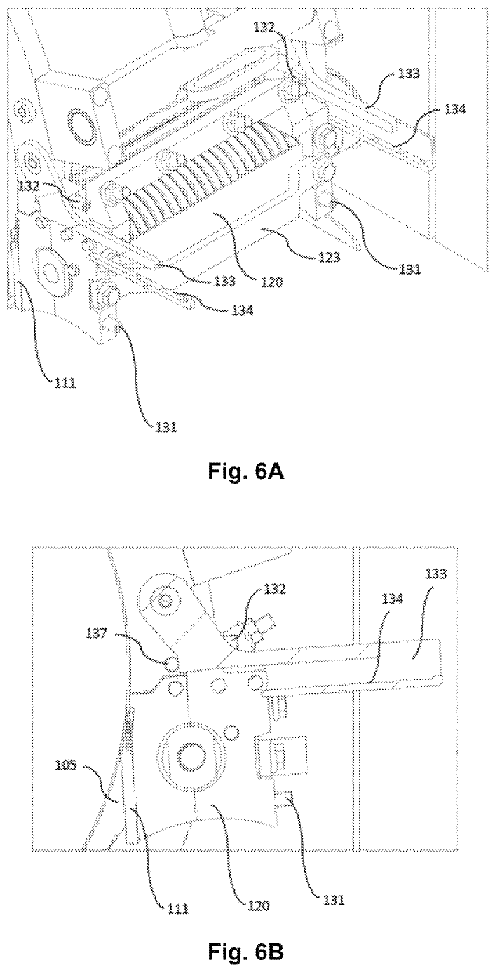

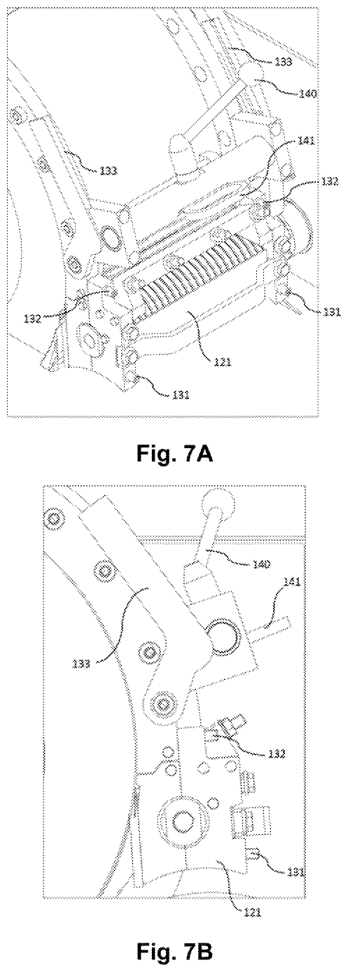

FIGS. 6A and 6B show a fourth situation in which the cutting tool housing 120 is in the first position, i.e. the use position. In this position, the support of the cutting tool housing has been taken over by the mounting studs 131, 132 and the protrusions 121 of the cutting tool housing are no longer in contact with the support surfaces 134. Subsequently, the cutting tool housing may be secured on the machine by screwing the mounting nuts 138 on the mounting studs 131, 132 and the guide arms 133 may be moved back to their storage position, as shown in FIGS. 7A and 7B.

### Gate

The gate 106 is a movable segment of the peripheral wall of the drum. In particular, the position of the gate can be adjusted in view of the slice thickness. For a larger slice thickness, the gate is opened more, and vice versa. In the embodiment shown in the drawings, the gate 106 hinges around an axis at the top side of the drum 105. In order to adjust the position of the gate, a lever 140 is provided which operates an internal blocking mechanism (not shown). When the blocking mechanism is released, the gate can be manually repositioned by pulling on the handle 141 which is fixed to the gate. Once the desired position is achieved, the blocking mechanism is moved back to the blocking state. Further fixing means may be used to secure the position of the gate 106 with respect to the drum 102.

In embodiments of the apparatus according to the present disclosure, the slice thickness may be primarily set or defined by means of the slice guide 112 and the gate 106 is positioned to match the position of the slice guide 112. This differs from prior art solutions wherein first the position of the gate was adjusted to the desired slice thickness and subsequently the position of a slice guide or like part was adjusted to compensate for the changed position of the gate. The slice guide was commonly mounted on the gate, so that the adjustment of the position of the slice guide meant a change in orientation in view of the gate being hinged on the drum. This made the adjustment cumbersome and often inaccurate.

In embodiments according to the present disclosure, the slice guide 112 is preferably mounted on the pre-assembled cutting tool housing 120. In this way, its position may be set accurately with respect to the slicing knife 111, which is preferably also provided on the cutting tool housing 120 (this will be explained in more detail below). Thus, the slice thickness is primarily set by means of the slice guide 112 and subsequently the position of the gate 106 is matched to the position of the slice guide 112.

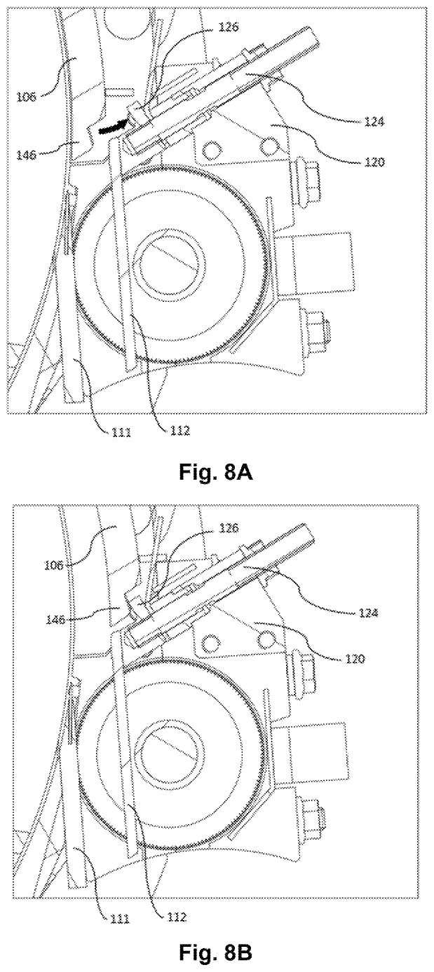

The position of the gate 106 may be set once the cutting tool housing 120 is in place on the machine. This is explained by means of FIGS. 8A and 8B.

FIG. 8A shows the gate in a released state, i.e. the blocking mechanism is released and the position of the gate can be manually adjusted by pulling on the lever 140. At a top side, the cutting tool housing 120 comprises an abutment edge 126 for the distal end 146 of the gate 106. This abutment edge 126 is provided on a part that is linked to the slice guide 112, or may even be an integral part of the slice guide. In any case, the position of this abutment edge 126 is tied to the position of the slice guide 112. In order to match the position of the gate to that of the slice guide, a user can now pull the gate 106 until the distal portion 146 of the gate abuts the abutment edge 126 and subsequently block the position of the gate 106 by means of the blocking mechanism. The movement of the gate 106 is shown in FIG. 8A by the arrow and the end result is shown in FIG. 8B.

As shown in the drawings, the distal portion 146 of the gate may be shaped complementary to the part comprising the abutment edge 126. Further, the fixing mechanism 124 which is used to fix the slice guide 112 on the cutting tool housing 120 is oriented such that the adjustment of the position of the slice guide 112 on the cutting tool housing occurs in a direction substantially parallel to the movement of the distal portion 146 of the gate and keeps the orientation of the slice guide 112 with respect to the slicing knife 111.

In embodiments according to the present disclosure, other means for adjusting the position of the gate with respect to the drum may be provided, such as for example a screw mechanism, for example with a manually rotatable knob so that the position of the gate may be adjusted by turning the knob, or with a motorized system for driving the screw mechanism. Other means known to the person skilled in the art may be applied as well.

In the embodiments shown in the drawings, the position of the slice guide 112 with respect to the slicing knife 111 (i.e. the slice thickness) is pre-set upon assembly of the cutting tool housing and cannot be adjusted while the cutting tool housing 120 is fixed on the machine. In embodiments within the present disclosure, the position of the slice guide 112 and/or the slice thickness may also be adjustable while the slice guide 112 is mounted on the machine 100.

### Cutting Tool Housing/Cutting Unit

As explained above, the cutting tool housing 120 and the cutting tools mounted thereon form a kind of removable or replaceable cutting unit for a cutting apparatus like the one shown in FIGS. 1-8. In the following, such cutting units will be described in more detail with reference to FIGS. 9-10.

FIGS. 9A and 9B show views of a first embodiment of a cutting unit 201, comprising a cutting tool housing 120 wherein cutting tools are provided and set for cutting a first slice thickness. This cutting unit 201 is the same one as the one shown on the apparatus of FIGS. 1-7.

The cutting unit 201 comprises the following set of cutting tools: slicing knife 111, slice guide 112 and circular cutter 113.

The slicing knife 111 is mounted on a front side of the housing 120 which is in use mounted against the peripheral wall 105 of the drum 106. The slicing knife is formed by an assembly of a holder 202 and a replaceable insert 203 on which the cutting edge is provided. The slicing knife has a first set of bores 204 by means of which the knife is bolted to the housing 120. The knife has a second set of bores 205 which are aligned with the bores 206 in the housing 210 for receiving the lower mounting studs 131 of the cutting apparatus 100.

The slice guide 112 is assembled at a predetermined distance from the slicing knife 111, which corresponds to the slice thickness in use. This distance is pre-set during assembly of the cutting unit by means of the fixing mechanism visible at the top of the cutting unit. In particular, this fixing mechanism comprises a number of fixing bolts 210 which are inserted through bores in a top block 209 of the cutting unit 201. A proximal end of these fixing bolts is connected with a part 208 to which also the slice guide 112 is connected. This part 208 comprises the abutment edge 126 for the gate 106, as described above with reference to FIGS. 8A and 8B. Between this part 208 and the top block 209, bushings 211 of predetermined length are inserted. These bushings 211 determine the distance between the slice guide 112 and the slicing knife 111 and as a result, the slice thickness. Fixing nuts 211 are screwed onto the distal ends of the fixing bolts 210 to fix these components together.

Thus, the slice thickness can be adjusted by exchanging the bushings 212 for bushings of another length. This fixing mechanism provides for a linear displacement of the slice guide 112, more particularly by exchanging the bushings for other bushings of a predetermined length, the orientation of the slice guide on the housing 120 remains the same. Preferably, the slice thickness which is set by means of the bushings is indicated on the outside of the bushings.

The orientation of the slice guide 112 is preferably such that it is extends substantially parallel to the surface of the slicing knife 111 that faces the slice guide, or at a small angle relative thereto such that the gap between the knife and the guide widens from top to bottom. This small angle may for example be in the range of 0.0 to 2.0°, preferably 0.1 to 1.0°, preferably about 0.5°. This angle has the effect that the gap through which a slice passes in use slightly widens towards the exit, which may reduce or eliminate the risk of obstruction or blockage, while simultaneously guiding and holding the slice for the successive cuts of the circular cutter 113 and possibly also a cross cutter 115. This angle is determined by the part 208 to which the slice guide 112 is fixed and which forms part of the fixing mechanism. In embodiments, the angle may be adjusted by exchanging the part 208 for another one with a different geometry. In embodiments, the slice guide 112 and the part 208 may be parts which are fixed to each other by fixing means (so that only the part 208 needs to be exchanged to adjust the angle) or parts which are permanently attached or integral with each other (so that the combination of part 208 with slice guide 112 needs to be exchanged to adjust the angle).

The fixing mechanism for the slice guide 112 is oriented at an angle with respect to horizontal. This angle is preferably chosen to match the direction in which the distal portion 146 of the gate 106 of the cutting apparatus moves, when the gate is set to the correct position to match the slicing thickness defined by the cutting unit 201. The part 208 of the cutting tool housing 210 comprises an abutment edge 126 which is provided as an abutment for the distal portion 146 of the gate of the apparatus. As shown in FIGS. 8A and 8B, the part 208 comprising the abutment edge 126 preferably has a complementary shape to the distal portion 146 of the gate.

The slice guide 112 may be formed by or comprise a generally straight plate with slots which accommodate the circular knives 114, i.e. the circular knives pass through these slots and extend towards the surface of the slicing knife. The circular cutter 113 comprises a plurality of circular knives 114 which are mounted on a spindle with spacers in between each pair of circular knives. The circular knives may be mounted at desired distances from each other, for example at equal distances from each other, which determines a width of strips that are cut by the circular cutter. The spindle of the circular cutter is provided for being coupled with a drive spindle of the machine by a part 119 which has the groove of a tooth and groove connection. The mating part 118 on the drive spindle of the machine has the complementary tooth. In this way, the circular cutter spindle can be connected to or disconnected from the drive spindle by a lateral movement.

In embodiments, the cutting tools on the housing 120 may also comprise a spindle with feed stars instead of the circular cutter 113. Such feed stars do not cut the slice of the product but engage the slice to move it forward to the cross cutter. Such a spindle with feed stars is shown in FIG. 11. In use, the feed stars protrude through the slots in the slice guide 112 like the circular knives of the circular cutter, but to a lesser extent so as to merely engage the product without cutting it.

The housing 120 is an assembly of various parts which are bolted together to form the housing while largely enclosing the circular cutter 113. The housing comprises bores 206 and 207 for respectively receiving the lower mounting studs 131 and the upper mounting studs 132 of the cutting apparatus. In use, the housing 120 is bolted to these mounting studs 131, 132. The housing further comprises sets of protrusions 121 on its sides. These are provided to cooperate with the auxiliary mounting system described elsewhere herein. The housing 120 is further equipped with handles 122, 123 to facilitate manipulation of the housing.

FIGS. 10A through 10E show views of a second embodiment of a cutting unit 301, comprising the same cutting tool housing 120 as the head 201 of FIG. 9 but wherein the cutting tools are set for cutting a second slice thickness. For reasons of brevity, only the difference with respect to FIG. 9 is explained. FIGS. 10A-10C show the completely assembled cutting unit 301; FIGS. 10D-10E show the cutting unit 301 with some parts removed.

In order to set the slice guide 112 at a different distance from the slicing knife 111, bushings 312 of different length are used. In particular, bushings 312 of shorter length are used compared to the bushings 212 of cutting unit 201, resulting in an increased distance between the slice guide 112 and the knife 111 and thus a higher slice thickness. The orientation of the slice guide 112 in the cutting unit 301 is the same as that in the cutting unit 201 of FIG. 9. In other words, the displacement of the slice guide 112 as a result of exchanging the bushings is linear.

In FIGS. 10D-10E show the cutting unit 301 with the slicing knife 111, slice guide 112 and part of its fixing mechanism removed. Only the top block 209 and the bushes 312 are shown. As can be seen in the cross-sectional view of FIG. 10E, the bores in the top block 209 and the bushes 312 preferably mate with each other, preferably such that the bushes 312 are partially insertable in the bores.

In a cutting system according to the present disclosure, multiple cutting units may be provided. For example, the cutting units 201 and 301 can simply be used alternately if a user wants to be able to easily switch between two different slice thicknesses. In general, multiple cutting units can be used as interchangeable units which can be removed from the apparatus for maintenance, cleaning, sharpening of cutting tools, replacement of worn parts etc. A set of interchangeable cutting units may be provided, so that a cutting unit which is removed for maintenance can be easily and quickly switched for another one and downtime of the machine can be minimized. Further, multiple different heads may be provided with each head being pre-assembled for a different cut of the product. For example, separate cutting units may be provided for different dimensions of slices, strips and/or dices, and/or for cutting different shapes such as for example crinkle fries. The interchangeability of the cutting units further has the advantage that switching one cutting unit for another one can be performed by a less skilled worker whereas the more skilled worker can focus on tasks like as disassembling and accurately reassembling the cutting units.

1. A cutting apparatus for cutting product into slices, strips or dices, the cutting apparatus comprising:
a feed drum to which product to be cut is fed and wherein the product is moved towards a peripheral opening in the drum; and
a set of cutting tools which are mounted at said peripheral opening in the drum and are provided for cutting the product, the set of cutting tools comprising at least a slicing knife for cutting a slice from the product and a slice guide;
wherein a slice thickness of the slice is defined by a distance between the slicing knife and the slice guide and is preset by means of a fixing mechanism that positions and fixes the slice guide with respect to the slicing knife;
wherein the fixing mechanism provides for a linear displacement of the slice guide with respect to the slicing knife to set the slice thickness while maintaining the orientation of the slice guide with respect to the slicing knife.

2. The cutting apparatus according to claim 1, wherein the set of cutting tools further comprises knives for cutting the slice into strips or dices.

3. The cutting apparatus according to claim 1, wherein the set of cutting tools comprises a circular cutter.

4. The cutting apparatus according to claim 1, wherein the set of cutting tools comprises a cross cutter.

5. The cutting apparatus according to claim 1, wherein at least one cutting tool of the set of cutting tools is mounted on a removable cutting tool housing.

6. The cutting apparatus according to claim 5, wherein the cutting apparatus comprises mounting studs for receiving the removable cutting tool housing.

7. The cutting apparatus according to claim 1, wherein the apparatus comprises an adjustable gate which is a movable segment of the drum leading up to the peripheral opening and wherein the apparatus comprises means for adjusting the position of the gate to match a slice thickness defined by means of the slice guide on the cutting tool housing.

8. The cutting apparatus according to claim 1, wherein the orientation of the slice guide is such that it is extends substantially parallel to a surface of the slicing knife that faces the slice guide.

9. The cutting apparatus according to claim 1, wherein the orientation of the slice guide is such that it is extends at a small angle relative to a surface of the slicing knife that faces the slice guide.

10. The cutting apparatus according to claim 9, wherein the small angle is in the range of 0.0 to 2.0°.

11. The cutting apparatus according to claim 1, wherein the apparatus comprises an adjustable gate which is a movable segment of the drum leading up to the peripheral opening and wherein the apparatus comprises means for adjusting the position of the gate to match a slice thickness defined by means of the slice guide on the cutting tool housing.

12. The cutting apparatus according to claim 11, wherein the cutting tool housing comprises an abutment edge as an abutment for a distal portion of the gate.

13. The cutting apparatus according to claim 1, wherein the set of cutting tools further comprises the circular cutter and/or the cross cutter for further cutting the slice into strips or dices.

14. A cutting unit, provided for being mounted on a cutting apparatus for cutting product into slices, strips or dices, the cutting unit comprising:
a cutting tool housing;
a set of cutting tools which are in use provided for cutting the product, the set of cutting tools comprising at least a slicing knife for cutting a slice from the product and a slice guide, at least one of said cutting tools being mounted on the cutting tool housing;
wherein a slice thickness for the cutting apparatus is preset on the cutting unit by means of a distance between the slicing knife and the slice guide;
wherein the slice guide is mounted on the cutting tool housing by means of a fixing mechanism which allows adjustment of the distance of the slice guide with respect to the slicing knife to set the slice thickness;
wherein the fixing mechanism provides for a linear displacement of the slice guide with respect to the slicing knife to set the slice thickness while maintaining the orientation of the slice guide with respect to the slicing knife.

15. The cutting unit according to claim 14, wherein the cutting tool housing comprises an abutment edge as an abutment for a gate of the cutting apparatus.

16. The cutting unit according to claim 14, wherein the set of cutting tools further comprises knives for cutting the slice into strips or dices.

17. The cutting apparatus according to claim 14, wherein the orientation of the slice guide is such that it is extends substantially parallel to a surface of the slicing knife that faces the slice guide.

18. The cutting apparatus according to claim 14, wherein the orientation of the slice guide is such that it is extends at a small angle relative to a surface of the slicing knife that faces the slice guide.

19. The cutting apparatus according to claim 14, wherein the small angle is in the range of 0.0 to 2.0°.

20. A cutting system comprising a cutting apparatus according to claim 1.
